(19) United States
(12) Patent Application Publication
(10) Pub. No.: US 2012/0242290 A1
(43) Pub. Date: Sep. 27, 2012

(54) BATTERY POWER SUPPLY DEVICE AND BATTERY POWER SUPPLY SYSTEM

(76) Inventor: Jun Asakura, Osaka (JP)

(21) Appl. No.: 13/514,459

(22) PCT Filed: Jun. 15, 2011
(86) PCT No.: PCT/JP2011/003418

§ 371 Date: Jun. 7, 2012

(30) Foreign Application Priority Data
Aug. 31, 2010 (JP) 2010-194403

(51) Int. Cl. H02J 7/00

(52) U.S. Cl. 320/118

(57) ABSTRACT

The battery power source apparatus includes a battery block formed by parallel-connecting series circuits each formed of a rechargeable battery and an interrupting device, a parallel circuit formed by parallel-connecting series circuits respectively formed of the interrupting devices and first resistors having respective one ends connected to connection points between the rechargeable batteries and the interrupting devices of the series circuits, and respective other ends connected to each other, a second resistor having one end connected to a connection point of the respective other ends, a power source unit applying voltage to a series circuit of the parallel circuit and the second resistor, a voltage divider ratio calculating unit calculating a voltage divider ratio between the parallel circuit and the second resistor, and a judging unit determining presence or absence of an activated interrupting device of the plurality of interrupting devices based on the voltage divider ratio.

### TECHNICAL FIELD

The present invention relates to a battery power source apparatus and a battery power source system using a battery block in which a plurality of series circuits each formed of a rechargeable battery and an interrupting device are connected in parallel.

### BACKGROUND ART

Conventionally, in battery power source apparatuses that supply power to a load circuit using rechargeable batteries, battery blocks having a plurality of parallel-connected rechargeable batteries have been widely used, because of the need to secure an amount of current output required by the load circuit. In such battery power source apparatuses, even if an open circuit occurs in some of the parallel-connected rechargeable batteries, the voltage output of the battery block is maintained by the remaining rechargeable batteries. It is therefore not easy to detect an open circuit in some of the rechargeable batteries.

In this respect, a technique is conventionally known for detecting an open circuit in a part of the rechargeable batteries by detecting the OCV (open circuit voltage) of the battery block when the battery block is charged or discharged, based on the fact that the difference in the OCV after charging or discharging changes when there is an open circuit in a part of the rechargeable batteries (see, for example, Patent Document 1).

Also known is a technique for detecting an open circuit in a part of the rechargeable batteries by detecting internal resistance of the battery block, based on the fact that the internal resistance of the battery block increases when there is an open circuit in some rechargeable batteries (see, for example, Patent Document 2).

However, with the technique described in Patent Document 1, the open circuit of the rechargeable battery cannot be detected unless the battery block is charged or discharged. Therefore, there is a long time lag from occurrence of an open circuit in a rechargeable battery until it is detected.

With the technique described in Patent Document 2, an open circuit of a rechargeable battery is detected based on the internal resistance of the battery block. The internal resistance of the battery block, in other words, is a combined resistance of the internal resistances of respective parallel-connected rechargeable batteries. The internal resistance of each rechargeable battery varies in accordance with various conditions such as the characteristics variation of respective rechargeable batteries, temperature environment, deterioration degree of respective rechargeable batteries, and the like. Because of this, the internal resistance of the battery block shows large variations and fluctuations, so that detection accuracy of an open circuit is low when detecting an open circuit in a rechargeable battery based on the internal resistance of the battery block.

Patent Document 1: Japanese Patent Application Laid-open No. 2008-71568

Patent Document 2: Japanese Patent Application Laid-open No. 2008-27658

### SUMMARY OF THE INVENTION

An object of the present invention is to provide a battery power source apparatus and a battery power source system with a battery block in which a plurality of series circuits each formed of a rechargeable battery and an interrupting device arc connected in parallel, with which the time required for detecting an activation of an interrupting device is reduced, and with which detection accuracy of the activation of the interrupting device is improved.

A battery power source apparatus according to one aspect of the present invention includes: a battery block formed by parallel-connecting a plurality of series circuits each formed of a rechargeable battery and an interrupting device for interrupting a charge and discharge path of the rechargeable battery; a plurality of first resistors having respective one ends connected to connection points between the rechargeable batteries and the interrupting devices of the respective series circuits, and respective other ends connected to each other; a second resistor having one end connected to a connection point of the respective other ends; a power source unit that applies voltage to a series circuit of a parallel circuit and the second resistor by applying voltage between a connection point of the plurality of interrupting devices and the other end of the second resistor, the parallel circuit being formed by the plurality of interrupting devices and the plurality of first resistors; a voltage divider ratio calculating unit that calculates a voltage divider ratio between the parallel circuit and the second resistor based on at least one of a voltage across the ends of the parallel circuit and a voltage across the ends of the second resistor; and a judging unit that determines presence or absence of an activated interrupting device of the plurality of interrupting devices based on the voltage divider ratio.

A battery power source system according to one aspect of the present invention includes the battery power source apparatus described above, and an external apparatus that charges and discharges the battery power source apparatus. The external apparatus includes a load circuit to which a discharge current is supplied from the plurality of battery blocks, a current supply unit that supplies a charge current to the plurality of battery blocks, and a charge/discharge control unit that adjusts the discharge current supplied from the plurality of battery blocks to the load circuit, and the charge current supplied from the current supply unit to the plurality of battery blocks such that current flowing through the battery blocks is within a range not exceeding the current limit value sent from the current control unit.

### BRIEF DESCRIPTION OF THE DRAWINGS

FIG. 1 is a block diagram showing one example of the battery power source apparatus according to a first embodiment of the present invention and the battery power source system including the same.

FIG. 2 is a circuit diagram showing one example of the details of the battery modules shown in FIG. 1.

FIG. 3 is a circuit diagram showing another example of the battery modules shown in FIG. 2.

FIG. 4 is a flowchart showing one example of the operation of the battery power source apparatus shown in FIG. 1.

FIG. 5 is a block diagram showing one example of the configuration of the battery power source system according to a second embodiment of the present invention.

FIG. 6 is an explanatory diagram showing one example of voltage divider ratio information stored in a memory unit shown in FIG. 5.

FIG. 7 is a flowchart showing one example of the operation of the battery power source apparatus shown in FIG. 5.

### DESCRIPTION OF EMBODIMENTS

Hereinafter, embodiments of the present invention will be described based on the drawings. Same reference numerals given to components in various drawings indicate that these are the same components and description thereof will be omitted.

### First Embodiment

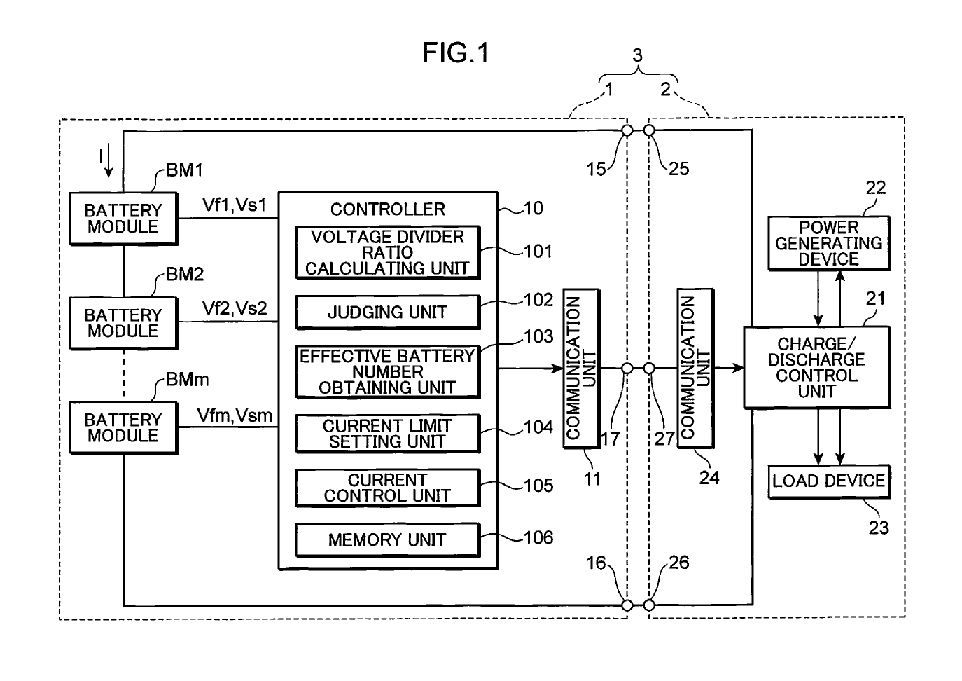

FIG. 1 is a block diagram showing one example of the battery power source apparatus according to the first embodiment of the present invention and the battery power source system including the same.

The battery power source system 3 shown in FIG. 1 is formed by a combination of a battery power source apparatus 1 and an external apparatus 2. The battery power source apparatus 1 shown in FIG. 1 includes a certain number m of battery modules BM1, BM2, . . . , BMm, a controller 10, a communication unit 11, and connection terminals 15, 16, and 17.

The certain number m of battery modules BM1, BM2, . . . , BMm are series connected. The positive electrode of the series circuit of the battery modules BM1, BM2, . . . BMm, i.e., the positive electrode of the battery module BM1, is connected to the connection terminal 15. The negative electrode of the series circuit of the battery modules BM1, BM2, . . . BMm, i.e., the negative electrode of the battery module BMm, is connected to the connection terminal 16. The connection terminal 17 is connected to the communication unit 11.

The number of battery modules is not limited to two or more but may be one. Hereinafter, the battery modules BM1, BM2, . . . BMm will collectively be represented as battery module BM, the number of each battery module will be represented by a module number i (i being an integer of 1 to m), and a battery module with a module number of i will be represented as battery module BMi. In the following description, with respect to other constituent elements, too, where a reference symbol includes only an upper-case letter or letters, with the number part omitted, it should be understood as collectively referring to the constituent elements denoted by the reference symbols having such an upper-case letter or letters in common

The external apparatus 2 shown in FIG. 1 includes a charge/discharge control unit 21, a power generating device 22, a load device 23, a communication unit 24, and connection terminals 25, 26, and 27. The connection terminals 25 and 26 are connected to the charge/discharge control unit 21, while the connection terminal 27 is connected to the charge/discharge control unit 21 via the communication unit 24. The power generating device 22 and the load device 23 are connected to the charge/discharge control unit 21. The power generating device 22 corresponds to one example of a current supply unit, and the load device 23 corresponds to one example of a load circuit.

When the battery power source apparatus 1 and the external apparatus 2 are combined, the connection terminals 15, 16, and 17 and the connection terminals 25, 26, and 27 are respectively connected to each other.

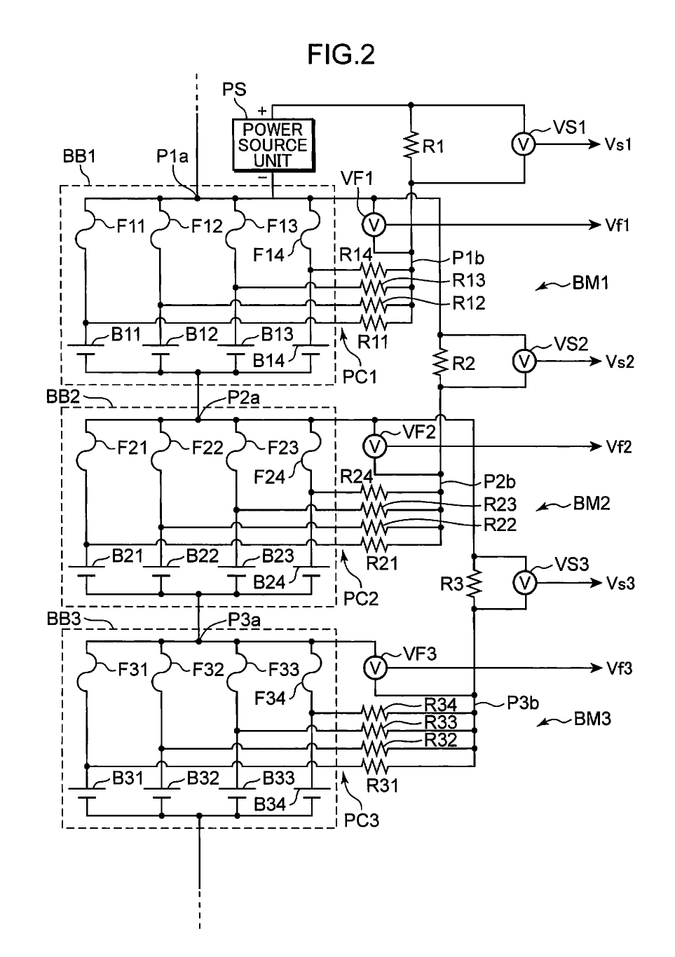

FIG. 2 is a circuit diagram showing one example of the details of the battery modules BM1, BM2, . . . , BMm shown in FIG. 1. For ease of explanation, FIG. 2 illustrates an example where the number m of the battery modules is 3. 100201 The battery module BM1 includes a battery block BB1, a power source unit PS, resistors R1, R11, R12. R13, and R14, and voltage detection units VF1 and VS1. The battery module BMi, where the module number i is 2 or more, includes a battery block BBi, resistors Ri, Ri1, Ri2, Ri3, and Ri4, and voltage detection units VFi and VSi.

The battery modules BBi includes fuses Fi1, Fi2, Fi3, and Fi4, and rechargeable batteries Bi1, Bi2, Bi3, and Bi4 connected in parallel to each other. The number of the rechargeable batteries contained in the battery block BBi will be represented by n. FIG. 2 shows an example where the number n of rechargeable batteries is 4.

Where i is the module number, which is also the number of the battery block, and j is the battery number of rechargeable batteries in each battery block (j being an integer of 1 to n), battery module BM, resistor R, voltage detection units VF and VS, fuse F, and rechargeable battery B, which correspond to a battery block BBi, are represented as battery module BMi, resistor Ri, resistors Ri1, Ri2, Ri3, and Ri4, voltage detection units VFi and VSi, fuses Fi1, Fi2, Fi3, and Fi4, and rechargeable batteries Bi1, Bi2, Bi3, and Bi4.

The fuse F and the resistor R corresponding to a rechargeable battery Bij are represented as fuse Fij and resistor Rij.

The resistors R11 to Rmn correspond to first resistors, while the resistors R1 to Rm correspond to second resistors.

For the rechargeable battery B, various rechargeable batteries such as lithium ion rechargeable batteries or nickel metal hydride rechargeable batteries may be used. The rechargeable battery B may be a cell, a plurality of series-connected cells, a plurality of parallel-connected cells, or a battery pack formed by combining a series connection and a parallel connection.

The fuse F corresponds to one example of an interrupting device. The interrupting device is not limited to fuses and may be other devices such as a PTC (Positive Temperature Coefficient) device or the like.

The battery block BBi is formed by parallel-connecting a series circuit of the rechargeable battery Bi1 and the fuse Fi1, a series circuit of the rechargeable battery Bi2 and the fuse Fi2, a series circuit of the rechargeable battery Bi3 and the fuse Fi3, and a series circuit of the rechargeable battery Bi4 and the fuse Fi4.

While one example is shown here where the number of the series circuits of fuses and rechargeable batteries contained in the battery block BBi, i.e., the number n of rechargeable batteries, is 4, the number n of rechargeable batteries may be 2 or 3, or 5 or more.

The battery blocks BB1 to BBm are connected in series. A connection point Pia of the fuses Fi1 to Fi4 of the battery block BBi where the module number i is 2 to m is connected to a connection point of rechargeable batteries Bi1 to Bi4 of the battery block BB (i-1). The battery block BB (i-1) corresponds to another battery block adjacent the fuse (interrupting device) side of the battery block BBi. One of the battery blocks BB2 to BBm having a module number i of 2 to m corresponds to a specified battery block.

The resistors Ri1, Ri2, Ri3, and Ri4 are each connected at one end to the connection points between the rechargeable batteries Bi1, Bi2, Bi3, and Bi4 and the fuses Fi1, Fi2, Fi3, and Fi4. The other ends of the resistors Ri1, Ri2, Ri3, and Ri4 are connected to each other at a connection point Pib. Thus, a parallel circuit PCi is formed, in which a series circuit of the fuse Fi1 and the resistor Ri1, a series circuit of the fuse Fi2 and the resistor Ri2, a series circuit of the fuse Fi3 and the resistor Ri3, and a series circuit of the fuse Fi4 and the resistor Ri4 are connected in parallel.

To the connection point P1b of the battery block BB1 having no other battery block adjacent on the fuse side is connected one end of the resistor R1, with the power source unit PS being connected between the other end of the resistor R1 and the connection point P1a. Thus the power source unit PS applies voltage to the series circuit of the parallel circuit PC1 and the resistor R1.

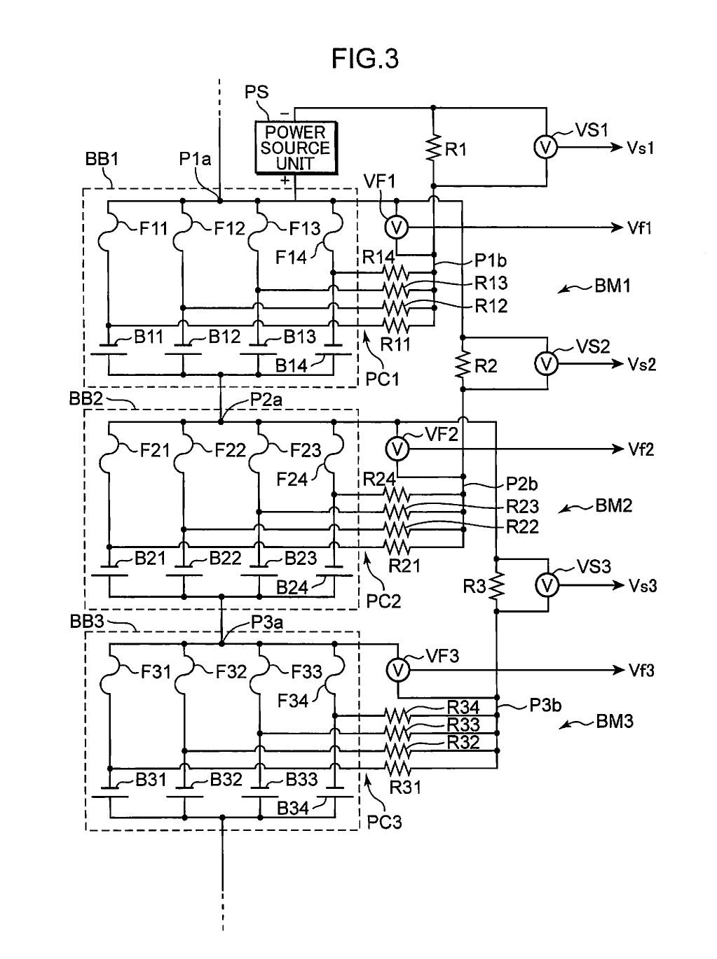

As shown in FIG. 2, when the positive electrode of the rechargeable battery B is connected to the fuse F, the power source unit PS is connected to have the negative electrode on the connection point P1a side and the positive electrode on the resistor R1 side. The rechargeable battery B may be connected oppositely from FIG. 2, in which case, as shown in FIG. 3, the power source unit PS is connected to have the positive electrode on the connection point P1a side and the negative electrode on the resistor R1 side.

The power source unit PS may take any form as long as it generates a preset voltage of, for example, 5 V, from the output voltage of the rechargeable batteries B11, B12, B13, and B14. For the power source unit PS, various power supply circuits may be used such as, for example, charge pump circuits, switching power supply circuits, and IC regulators or the like.

One end of the resistor Ri is connected to the connection point Pib of the battery block BBi (i being an integer of 2 to m) which is the specified battery block, while the other end of the resistor Ri is connected to the connection point P(i-1) a of the battery block adjacent on the fuse side. Thus the battery block BB(i-1) functions as a power source unit that applies voltage to the series circuit of the parallel circuit PCi and the resistor Ri.

The voltage detection units VF and VS are voltage detection circuits formed using, for example, an analog/digital converter.

The voltage detection unit VFi is connected between the connection point Pia and the connection point Pib. The voltage detection unit VFi detects a voltage Vfi across the connection point Pia and the connection point Pib and outputs a signal indicative of the voltage Vfi to the controller 10.

The voltage detection unit VSi is connected between the ends of the resistor Ri. The voltage detection unit VSi detects a voltage Vsi across the ends of the resistor Ri and outputs a signal indicative of the voltage Vsi to the controller 10.

While one example has been shown in which the voltage detection units VF and VS are included in the battery module BM, the voltage detection units VF and VS may be included, for example, in the controller 10.

Referring back to FIG. 1, the communication units 11 and 24 are communication interface circuits, and with the connection terminals 17 and 27 connected thereto, data can be sent and received between the communication units 11 and 24. The controller 10 and the charge/discharge control unit 21 can send and receive data to and from each other via the communication units 11 and 24.

The controller 10 is formed to include, for example, a CPU (Central Processing Unit) performing predetermined arithmetic operations, a ROM (Read Only Memory) storing predetermined control programs, a RAM (Random Access Memory) temporarily storing data, a memory unit 106 formed by, for example, an EEPROM (Electrically Erasable and Programmable Read Only Memory), and peripheral circuits thereof The controller 10 executes a control program stored in the ROM, for example, to function as a voltage divider ratio calculating unit 101, a judging unit 102, an effective battery number obtaining unit 103, a current limit setting unit 104, and a current control unit 105.

The voltage divider ratio calculating unit 101 calculates a voltage divider ratio Xi between the parallel circuit PCi and the resistor Ri in the respective battery modules BM with the module number i being 1 to m using, for example, the following Equation (1), based on the voltages Vf1 to Vfm and voltages Vs1 to Vsm detected by the voltage detection units VF and VS.

Voltage divider ratio Xi=Vfi/Vsi (1).

While one example has been shown in which the voltage detection unit VFi detects the voltage across the ends of the parallel circuit PCi, the voltage detection unit VFi may output a voltage across the ends of the series circuit of the parallel circuit PCi and the resistor Ri (voltage across the terminal opposite from the connection point Pib of the resistor Ri and the connection point Pia) as the voltage Vfi. Alternatively, the voltage detection unit VFi may output the voltage across the ends of the series circuit of the parallel circuit PCi and the resistor Ri as the voltage Vfi, while the voltage detection unit VSi outputs the voltage across the ends of the parallel circuit PCi (voltage across the connection point Pia and the connection point Pib) as the voltage Vsi.

The voltage divider ratio calculating unit 101 may use the following Equation (2) instead of Equation (1):

Voltage divider ratio Xi=Vsi/Vfi (2).

The judging unit 102 determines whether or not any of the fuses F11 to Fmn has been activated (has blown) based on the voltage divider ratio Xi calculated by the voltage divider ratio calculating unit 101, and obtains the number of activated fuses F per each battery block.

Namely, the voltage divider ratio Xi is determined by a ratio between the resistance value rfi of the parallel circuit PCi and the resistance value ri of the resistor Ri. The resistance value rfi can be obtained by the following Equation (3), where ri1, ri2, ri3, and ri4 respectively represent the resistance values of the resistors Ri1, Ri2, Ri3, and Ri4:

Resistance value rfi=1/{(1/ri1)+(1/ri2)+(1/ri3)+(1/ri4)} (3),

where the resistance value ri, and the resistance values ri1, ri2, ri3, and ri4 are preset fixed values.

If, for example, the fuse Fi2 is activated, the resistance value rfi equals to 1/{(1/ri1)+(1/ri3)+(1/ri4)}. If, for example, the fuses Fi2 and Fi3 are activated, the resistance value rfi equals to 1/{(1/ri1)+(1/ri4)}. Thus, the resistance value rfi changes in accordance with the number of activated fuses F included in the battery block BBi.

This means that the voltage divider ratio Xi also changes in accordance with the number of activated fuses F.

Therefore, a corresponding relation between the number of activations, which is the number of activated fuses F, and the voltage divider ratio X is preliminarily determined, and stored in the memory unit 106 as a look-up table.

The judging unit 102 obtains the number of activations Y stored correspondingly to a voltage divider ratio Xi using, for example a look-up table stored in the memory unit 106, as the number of activations Yi of fuses F in a battery block BBi. The judging unit 102 may obtain the number of activations Yi by mathematical calculations.

The judging unit 102 need not necessarily obtain the number of activations Yi. For example, a voltage divider ratio when none of the fuses F is activated may be stored beforehand as a reference voltage divider ratio in the memory unit 106, and the judging unit 102 may determine the presence of an activated fuse F in a battery block BBi if the voltage divider ratio Xi differs from the reference voltage divider ratio.

The effective battery number obtaining unit 103 calculates the number of effective batteries EN1 to ENm, which is the number of the rechargeable batteries B series-connected to intact fuses F in the battery blocks BB1 to BBm based on, for example, the number of activations Yi obtained by the judging unit 102, the number of rechargeable batteries n, and the following Equation (4):

Number of effective batteries ENi=n−Yi (4).

One alternative is to store a corresponding relation between, for example, the number of effective batteries EN and the voltage divider ratio X beforehand as a look-up table in the memory unit 106, the effective battery number obtaining unit 103 obtaining the number of effective batteries EN from the voltage divider ratio X by referring to this look-up table.

The current limit setting unit 104 sets a current limit value Iu indicative of a tolerable upper limit of current flowing through the battery block BB. More specifically, an upper limit value at which a battery block can be charged and discharged when all the rechargeable batteries included in this battery block are normal is preset as a standard current limit value Is.

Different values of the standard current limit value Is may be used for when charging and when discharging. Or, the standard current limit value Is may be changed in accordance with the state of charge (SOC) of the battery, temperature, or the like.

For example, since deterioration tends to progress more during charging than during discharging at high temperatures, the standard current limit value Is (charge) used for charging may be set lower than the standard current limit value Is (discharge) used for discharging.

The current limit setting unit 104 selects the smallest value of the numbers of effective batteries EN1 to ENm obtained by the effective battery number obtaining unit 103 as the number of effective batteries ENmin, and calculates a current limit value Iu based on the following Equation (5):

Iu=Is×ENmin/n (5).

The current control unit 105 sends the current limit value Iu set by the current limit setting unit 104 to the charge/discharge control unit 21 by means of the communication unit 11 via the communication unit 24. The current control unit 105 thus causes the charge/discharge control unit 21 to execute control such that the current I flowing through the battery block BB does not exceed the current limit value Iu.

Next, the external apparatus 2 will be described. The power generating device 22 is, for example, a solar power generating system (solar cell), or a generator driven by, for example, natural energy such as wind power or hydropower, or artificial energy such as an engine. The charge/discharge control unit 21 may be connected to a commercial power supply, for example, instead of the power generating device 22.

The load device 23 is a load of various sorts driven by power supplied from the battery power source apparatus 1, and may be load equipment such as a motor or a back-up object.

The charge/discharge control unit 21 charges the battery blocks BB1 to BBm of the battery power source apparatus 1 with surplus power from the power generating device 22 or regenerative power generated by the load device 23. If there is a surge in consumption current at the load device 23, or if the power demand of the load device 23 exceeds the output of the power generating device 22 due to a decrease in power generation in the power generating device 22, the charge/discharge control unit 21 supplies power to the load device 23 from the battery blocks BB1 to BBm of the battery power source apparatus 1 to compensate for the shortfall.

Furthermore, the charge/discharge control unit 21 receives a current limit value Iu from the current limit setting unit 104 via the communication units 11 and 24 and controls the charging and discharging current value so that the current value I, when charging and discharging the battery blocks BB1 to BBm, does not exceed the current limit value Iu as described in the foregoing.

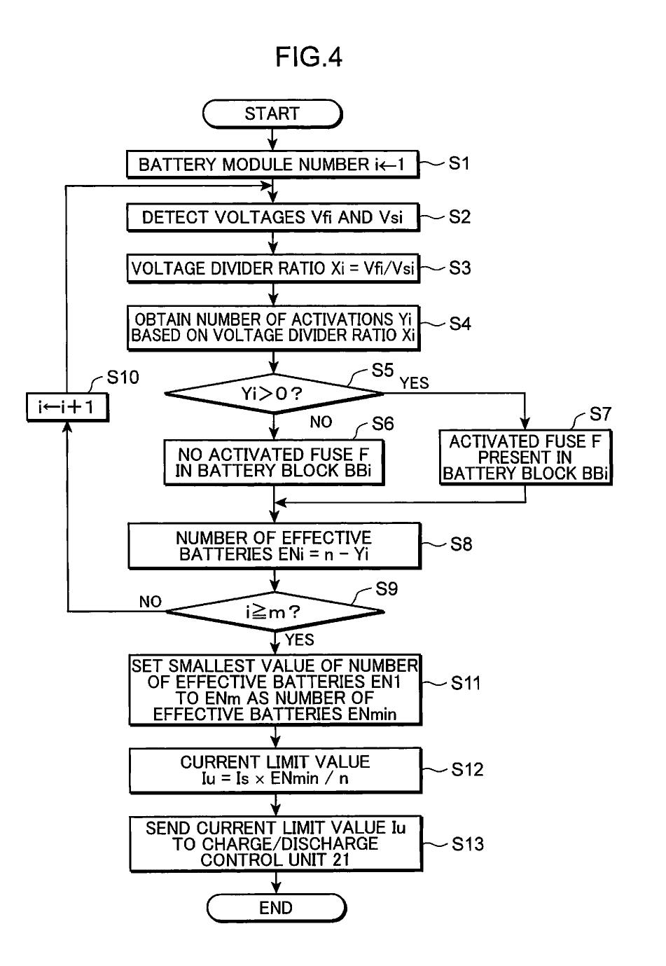

Next, how the battery power source system 3 configured as described above operates will be described. FIG. 4 is a flowchart showing one example of the operation of the battery power source apparatus 1 shown in FIG. 1. First, when none of the fuses F11 to Fmn is activated yet, the standard current limit value Is is set as an initial current limit value Iu by the current limit setting unit 104, this current limit value Iu being notified to the charge/discharge control unit 21 by the current control unit 105.

The absolute value of the value I of current that flows through the battery blocks BB1 to BBm is thus limited by the charge/discharge control unit 21 so as not to exceed the standard current limit value Is.

Next, at step S1, the controller 10 assigns 1 to the variable i indicative of the battery module BM number (step S1). Next, the voltage detection units VFi and VSi detect voltages Vfi and Vsi (step S2). The voltage divider ratio calculating unit 101 then calculates the voltage divider ratio Xi based on the voltages Vfi and Vsi (step S3).

Next, the judging unit 102 obtains the number of activations Yi based on the voltage divider ratio Xi (step S4). Next, the judging unit 102 compares the number of activations Yi with 0, and if the number of activations Yi is 0 (NO at step S5), the judging unit 102 determines that the battery block BBi does not include an activated fuse F (step S6).

On the other hand, if the number of activations Yi is more than 0 (YES at step S5), the judging unit 102 determines that the battery block BBi includes an activated fuse F (step S7). The judging unit 102 may send the judgment result of whether or not there is an activated fuse F to the external apparatus 2, for example, by means of the communication unit 11, or, for example, may display the result on a display device (not shown) to notify the user.

Next, the effective battery number obtaining unit 103 calculates the number of effective batteries ENi based on Equation (4) (step S8).

Next, the current limit setting unit 104 compares the variable i with the battery block number m, and if the variable i is smaller than the battery block number m (NO at step S9), 1 is added to the variable i to perform the process with respect to a next battery block BB (step S10), and steps S2 to S9 are repeated again.

When the variable i is equals to or more than the battery block number m (YES at step 9), it means that detection of activated fuses F and calculation of the numbers of effective batteries EN1 to ENm have been completed for all the battery blocks BB, and so the process goes to step S11.

As described above, through the process of steps S1 to S10, the presence or number of activated fuses F can be detected without charging and discharging the battery blocks BB, so that the time required for detecting an activation of a fuse F can readily be made shorter than that of the technique described in Patent Document 1. Also, since the presence or number of activated fuses F can be detected independently of the internal resistance of the battery blocks BB, it is easy to improve accuracy of detecting an activation of an interrupting device as compared to the technique described in Patent Document 2.

At step S11, the current limit setting unit 104 sets the smallest value of the numbers of effective batteries EN1 to ENm as the number of effective batteries ENmin (step S11).

Next, the current limit setting unit 104 calculates the current limit value Iu using the above Equation (5) (step S12). In accordance with Equation (5), the current limit value Iu is set such that the smaller the number of effective batteries ENmin, the lower the current limit value Iu.

By thus setting the current limit value Iu based on the number of effective batteries ENmin, the current limit value Iu is set appropriately for a battery block that includes a largest number of activated fuses F and thus most needs to be charged and discharged at a reduced current.

Next, the current limit value Iu is output to the communication unit 11 by the current control unit 105. This current limit value Iu is then sent to the charge/discharge control unit 21 (step S13) by the communication unit 11 via the communication unit 24, and the process ends.

The charge/discharge control unit 21 thus limits the current flowing through the battery blocks BB in the battery power source apparatus 1 so as not to exceed the current limit value Iu, whereby the current flowing through the battery blocks BB can be limited appropriately for a battery block that includes a largest number of activated interrupting devices and thus most needs to be charged and discharged at a reduced current. As a result, deterioration of the rechargeable batteries in the battery block that includes a largest number of activated interrupting devices can be reduced.

### Second Embodiment

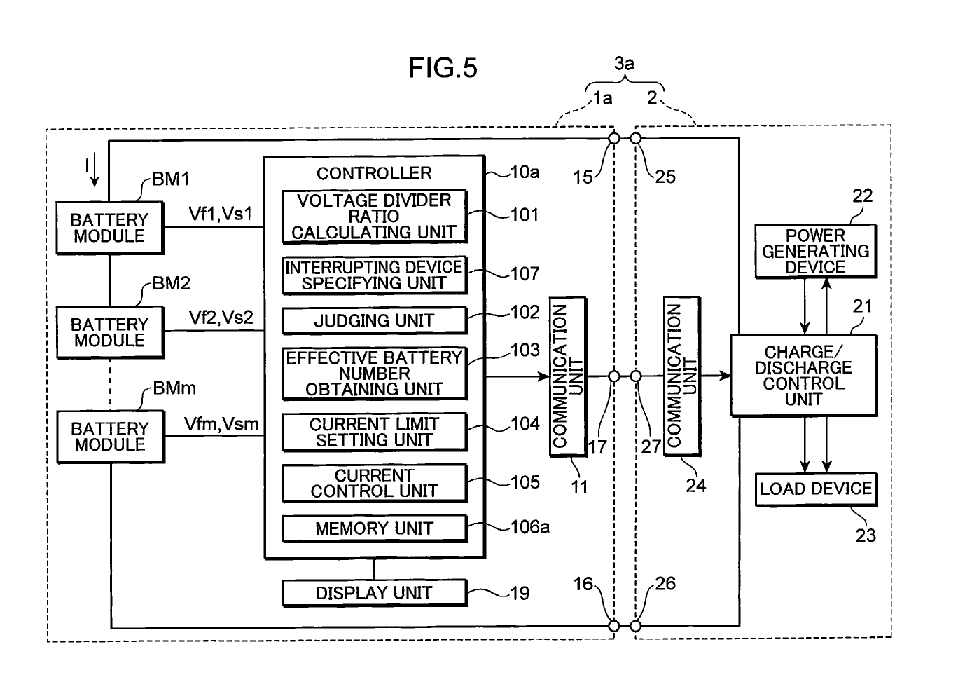

Next, the battery power source apparatus 1a according to a second embodiment of the present invention and the battery power source system 3a having the same will be described. FIG. 5 is a block diagram showing one example of the configuration of the battery power source system 3a according to the second embodiment of the present invention. The battery power source system 3a shown in FIG. 5 is different from the battery power source system 3 shown in FIG. 1 in that the battery power source apparatus 1a includes a display unit 19, the controller 10a includes an interrupting device specifying unit 107, and that the resistance values ri1, ri2, ri3, and ri4 of the resistors Ri1, Ri2, Ri3, and Ri4 are set differently from each other, and also, the look-up table stored in the memory unit 106a is different.

The display unit 19 is a display device such as a liquid crystal display device or an LED (Light Emitting Diode). The display unit 19 need not necessarily be provided to the battery power source apparatus 1a, but may be provided to the external apparatus 2.

Other components arc the same as those of the battery power source system 3 shown in FIG. 1 and description thereof will be omitted. The characteristic features of the battery power source apparatus 1a will be described below.

The resistance value rij of the resistor Rij corresponding to the battery number j of the battery block BBi equals to each term of the geometric progression expressed by the following Equation (6):

rij=ar^{j-1} (6),

where a is an arbitrary constant and r represents a value larger than 0 and except for 1.

The common ratio r may be any number larger than 0 and except for 1, such as, for example, 0.5, 1.5, or 3.5. If the common ratio r is an integer of 2 or more, the difference in voltage divider ratio will be clear, whereby it will be easier to detect an activated fuse F.

If the common ratio r is 2, for example, the resistance values ri1, ri2, ri3, and ri4 of the resistors Ri1, Ri2, Ri3, and Ri4 will be a, 2a, 4a, and 8a, respectively. With the resistance values of the resistors R being set this way, in a case where one or a plurality of resistors are selected and combined out of the resistors Ri1, Ri2, Ri3, and Ri4, the resistance values of the combined resistance, obtained when the resistors of the combinations are connected in parallel, i.e., the resistance value rfi of the parallel circuit PCi, will be different, if the combinations of the resistors are different.

The resistance values of the resistors R need not necessarily be set in accordance with Equation (6). It is only necessary that the respective resistance values are set such that, in a case where one or a plurality of resistors are selected and combined out of the resistors Ri1, Ri2, Ri3, and Ri4, the resistance values of the combined resistance, obtained when the resistors of the combinations are connected in parallel, will be different, if the combinations of the resistors are different.

With the resistance values ri1, ri2, ri3, and ri4 set differently from each other, the resistance value rfi, in above-described Equation (3), changes in accordance with the battery number j of an activated fuse Fij. Even if a plurality of fuses Fi are activated, the resistance value rfi changes in accordance with the combination of these activated fuses.

This in turn means that the voltage divider ratio Xi changes in accordance with the combination of activated fuses F.

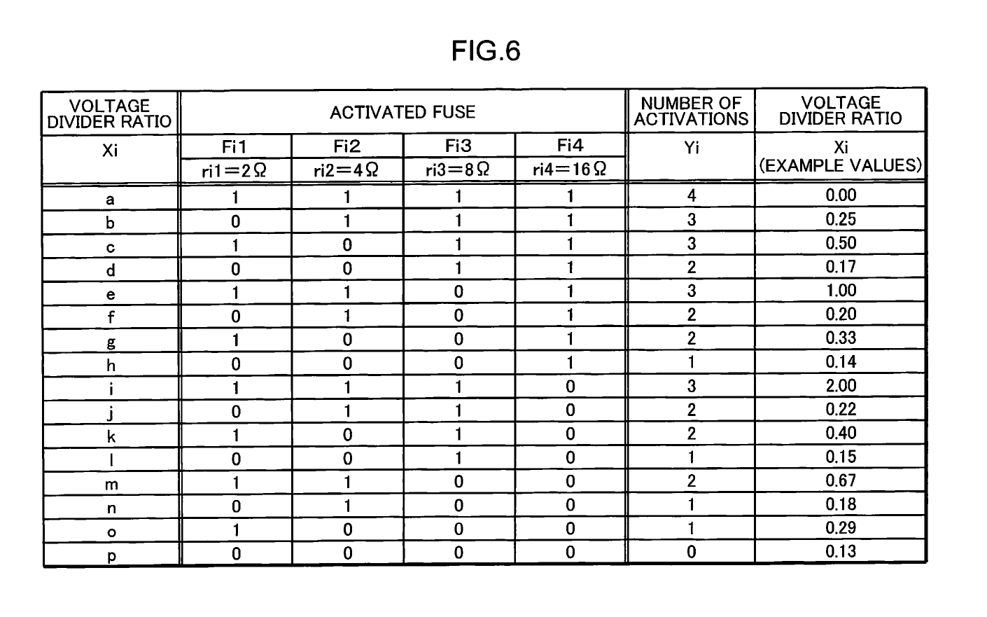

Therefore, voltage divider ratio information that matches a voltage divider ratio X with information specifying an activated fuse F is preliminarily determined, and stored in the memory unit 106a as a look-up table. FIG. 6 is an explanatory diagram showing one example of voltage divider ratio information stored in the memory unit 106a shown in FIG. 5.

In the column headed “activated fuse” in the look-up table shown in FIG. 6, 0 indicates that the corresponding fuse is not activated, whereas 1 indicates that the corresponding fuse is activated. The look-up table shown in FIG. 6 indicates that, if, for example, the voltage divider ratio Xi is b, the number of activations Yi is 3, with the fuses Fi2, Fi3, and Fi4 being activated. If, for example, the voltage divider ratio Xi is k, the number of activations Yi is 2, with the fuses Fi1 and Fi3 being activated. If, for example, the voltage divider ratio Xi is p, the number of activations Yi is 0, with none of the fuses Fi1, Fi2, Fi3, and Fi4 being activated.

In the right end column of the look-up table shown in FIG. 6 are shown example values of specific voltage divider ratios Xi when, for example, the resistance value ri1 is 2 Ω, the resistance value ri2 is 4 Ω, the resistance value ri3 is 8 Ω, the resistance value ri4 is 16 Ω, and the resistance value ri is 8 Ω.

The interrupting device specifying unit 107 specifies one of the fuses stored correspondingly to a voltage divider ratio Xi as an activated fuse, based on a voltage divider ratio Xi calculated by the voltage divider ratio calculating unit 101 using, for example, the look-up table stored in the memory unit 106a. Note, the interrupting device specifying unit 107 may specify the activated fuse through mathematical operations.

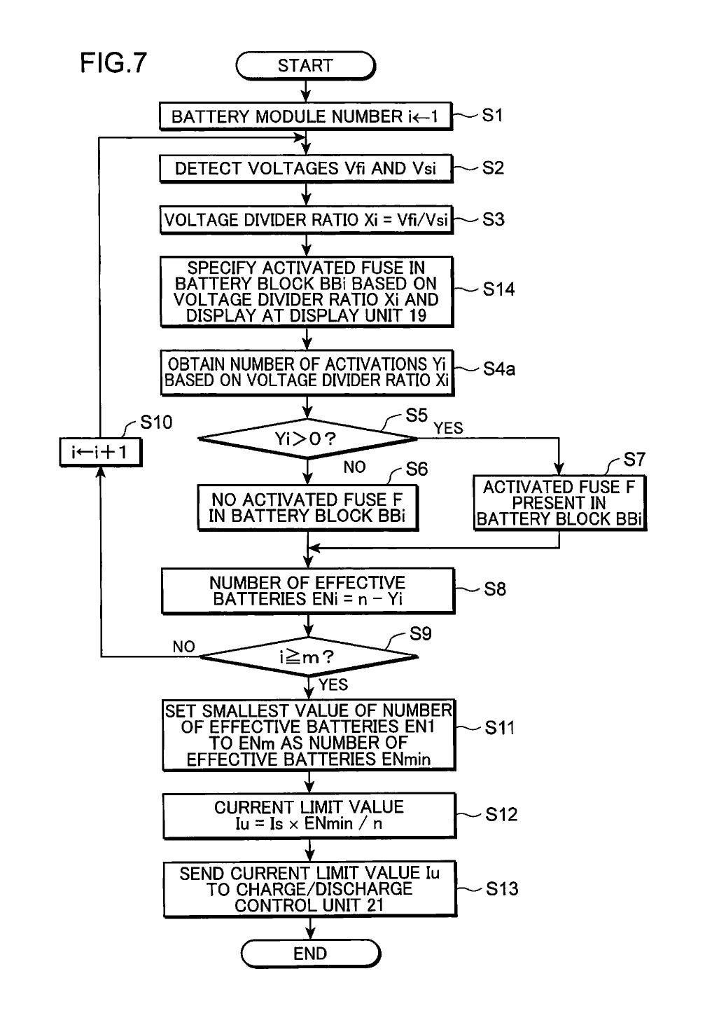

Next, how the battery power source system 3a shown in FIG. 5 operates will be described. FIG. 7 is a flowchart showing one example of the operation of the battery power source apparatus 1a shown in FIG. 5. Same processes as those of the flowchart shown in FIG. 4 are given the same step numbers and description thereof will be omitted.

In the flowchart shown in FIG. 7, following step S3, the interrupting device specifying unit 107 specifies one of the fuses stored correspondingly to a voltage divider ratio Xi as an activated fuse, based on the voltage divider ratio Xi using, for example, the look-up table of FIG. 6 stored in the memory unit 106a. The interrupting device specifying unit 107 then displays the information indicating the activated fuse at the display unit 19 (step S14).

This enables the user to specify, if any, which fuse is activated, and thus makes the maintenance of the battery power source apparatus 1a easy.

Next, at step S4a, similarly to step S4 shown in FIG. 4, the look-up table stored in the memory unit 106a is looked up to obtain the number of activations Yi based on the voltage divider ratio Xi (step S4a).

The processes onward are the same as those of the flowchart shown in FIG. 4 and the description thereof will be omitted.

While one example has been shown in which a plurality of battery modules BM are series-connected, the battery power source apparatus 1 or 1a may be configured to include only one battery module BM1. In that case, steps S9, S10, and S11 are omitted, and the number of effective batteries ENi obtained at step S8 may be used instead of the number of effective batteries ENmin.

Also, while one example has been shown in which the charge/discharge control unit 21 is provided to the external apparatus 2 so that the charge/discharge current value is limited by the charge/discharge control unit 21 with the current limit value Iu being sent by means of the communication unit 11, another configuration would be possible in which, for example, the battery power source apparatus 1 or 1a includes the charge/discharge control unit 21.

The battery power source apparatus 1 or 1a may be configured without the effective battery number obtaining unit 103, the current limit setting unit 104, and the current control unit 105 so that it does not perform steps S8, S11, S12, and S13.

Namely, a battery power source apparatus according to one aspect of the present invention includes: a battery block formed by parallel-connecting a plurality of series circuits each formed of a rechargeable battery and an interrupting device for interrupting a charge and discharge path of the rechargeable battery; a plurality of first resistors having respective one ends connected to connection points between the rechargeable batteries and the interrupting devices of the respective series circuits, and respective other ends connected to each other; a second resistor having one end connected to a connection point of the respective other ends; a power source unit that applies voltage to a series circuit of a parallel circuit and the second resistor by applying voltage between a connection point of the plurality of interrupting devices and the other end of the second resistor, the parallel circuit being formed by the plurality of interrupting devices and the plurality of first resistors; a voltage divider ratio calculating unit that calculates a voltage divider ratio between the parallel circuit and the second resistor based on at least one of a voltage across the ends of the parallel circuit and a voltage across the ends of the second resistor; and a judging unit that determines presence or absence of an activated interrupting device of the plurality of interrupting devices based on the voltage divider ratio.

With this configuration, the series circuits of the interrupting devices and the first resistors, in the plurality of series circuits forming the battery block, are connected in parallel to form a parallel circuit. The second resistor is connected to one end of this parallel circuit (connection point of the respective other ends) to form a series circuit of the parallel circuit and the second resistor. The power source unit applies voltage to this series circuit of the parallel circuit and the second resistor. This causes the voltage across the ends of the parallel circuit, and the voltage across the ends of the second resistor, to be generated in accordance with a voltage divider ratio between the parallel circuit and the second resistor. Thus, the voltage divider ratio calculating unit calculates a voltage divider ratio between the parallel circuit and the second resistor based on at least one of the voltage across the ends of the parallel circuit and the voltage across the ends of the second resistor.

An activation of an interrupting device changes the resistance value of the parallel circuit, which in turn changes the voltage divider ratio. Thus, the judging unit can determine presence or absence of an activated interrupting device of the plurality of interrupting devices based on the voltage divider ratio calculated by the voltage divider ratio calculating unit. With this, since presence or absence of an activated interrupting device can be determined without charging and discharging the rechargeable batteries, and irrespective of the internal resistance of respective rechargeable batteries, the time required for detecting an activation of an interrupting device can be readily reduced, and detection accuracy of an activation of an interrupting device can be readily improved.

Preferably, a plurality of the battery blocks are provided, the plurality of the battery blocks and connected in series, the plurality of first resistors and the second resistor are provided corresponding to each of the battery blocks, the parallel circuit is formed in plurality corresponding to the battery blocks, of the plurality of battery blocks, a specified battery block, which is a battery block having another battery block adjacent and connected thereto on a side of the interrupting device, uses this other battery block adjacent on the side of the interrupting device as the power source unit, the other end of the second resistor corresponding to the specified battery block is connected to a connection point of a plurality of interrupting devices included in this other battery block adjacent on the side of the interrupting device of the specified battery block, the voltage divider ratio calculating unit calculates respective voltage divider ratios corresponding to the respective battery blocks, and the judging unit determines presence or absence of an activated interrupting device of the plurality of interrupting devices for each of the battery blocks, based on each of the voltage divider ratios.

With this configuration, a plurality of battery blocks, which are each formed by parallel-connecting a plurality of series circuits of rechargeable batteries and interrupting devices, are connected in series. The plurality of first resistors and the second resistor are provided corresponding to each of the battery blocks. Namely, respective one ends of the plurality of first resistors are connected to connection points between rechargeable batteries and interrupting devices of respective series circuits of respective battery blocks, and respective other ends are connected to each other, to form a plurality of parallel circuits corresponding to respective battery blocks. Respective one ends of the second resistors are connected to respective parallel circuits, so that a series circuit of the parallel circuit and the second resistor is formed corresponding to each of the battery blocks.

Here, of the plurality of battery blocks, a battery block having another battery block adjacent and connected thereto on a side of the interrupting device, is referred to as a specified battery block. The other end of the second resistor corresponding to the specified battery block is connected to a connection point between a plurality of interrupting devices included in this other battery block adjacent on the side of the interrupting device of this specified battery block. This means that the output voltage of this other battery block is applied to the series circuit of the parallel circuit and the second resistor in this specified battery block, i.e., the other battery block adjacent the specified battery block on the side of the interrupting device functions as the power source unit for the specified battery block.

Thus the voltage divider ratio calculating unit can calculate the respective voltage divider ratios corresponding to the respective battery blocks, and hence, the judging unit can determine presence or absence of an activated interrupting device of the plurality of interrupting devices for each of the battery blocks. Since there is no need to provide a separate power source unit for the specified battery block, the configuration of the battery power source apparatus can be made simple.

Preferably, the judging unit obtains, for each of the battery blocks, a number of activated interrupting devices of the plurality of interrupting devices included in each of the battery blocks, based on each of the voltage divider ratios corresponding to the battery blocks.

A change in the number of activated interrupting devices of the plurality of interrupting devices included in each battery block changes the resistance value of the parallel circuit. A change in the resistance value of the parallel circuit changes the corresponding voltage divider ratio. Thus the voltage divider ratio in each battery block changes in accordance with the number of activated interrupting devices in each battery block, and thus the judging unit can obtain the number of activated interrupting devices in each battery block, based on the respective voltage divider ratios corresponding to the respective battery blocks, for each battery block.

Preferably, an effective battery number obtaining unit is further provided, which obtains a number of non-activated interrupting devices of the plurality of interrupting devices included in each of the battery blocks as a number of effective batteries for each of the battery blocks, based on each of the voltage divider ratios corresponding to the battery blocks.

Similarly to the number of activated interrupting devices described above, the voltage divider ratio in each battery block changes in accordance with the number of non-activated interrupting devices in each battery block. Thus the effective battery number obtaining unit can obtain the number of non-activated interrupting devices in respective battery blocks as the number of effective batteries corresponding to the respective battery blocks, based on the respective voltage divider ratios corresponding to the respective battery blocks. In this case, the number of effective batteries indicates the number of useable rechargeable batteries in respective battery blocks.

Preferably, a current limit setting unit is further provided, which sets a current limit value indicative of a tolerable upper limit of current flowing through the plurality of battery blocks, the current limit setting unit setting the current limit value such that the smaller a minimum value of the number of effective batteries corresponding to each of the battery blocks obtained by the effective battery number obtaining unit is, the lower the current limit value is.

When some of the interrupting devices included in a battery block are activated, the current that was flowing through the activated interrupting devices is distributed to the rechargeable batteries connected to the remaining non-activated interrupting devices. The current flowing through the remaining intact rechargeable batteries is thus increased. Therefore, if the battery power source apparatus were charged and discharged based on a current limit value indicative of a tolerable upper limit of current flowing through a battery block applicable when none of the interrupting devices is activated, even though the current flowing per each battery block would be no greater than the current limit value, i.e., within the tolerable range, the current flowing through the remaining intact rechargeable batteries would exceed a tolerable current value per one rechargeable battery and might possibly deteriorate the rechargeable battery.

Therefore, the effective battery number obtaining unit obtains the number of non-activated interrupting devices of the plurality of interrupting devices included in one battery block as the number of effective batteries, and the current limit setting unit sets the current limit value such that the smaller the number of effective batteries detected by the effective battery number obtaining unit is, the lower the current limit value is. Thereby, when some of the interrupting devices included in a battery block are activated, the number of effective batteries reduces, and the current limit value is set lower, so that, by charging and discharging the battery power source apparatus based on this current limit value, the current flowing through the remaining intact rechargeable batteries is reduced, as a result of which the risk of the remaining intact rechargeable batteries being deteriorated is readily reduced.

Preferably, the current limit setting unit sets a value, obtained by multiplying a standard current limit value. which is a current limit value when none of the plurality of interrupting devices included in each of the battery blocks is activated, by a ratio of the number of effective batteries to the number of rechargeable batteries included in one of the battery blocks, as the current limit value.

With this configuration, the current flowing through respective battery blocks is limited not to exceed the current limit value set by the current limit setting unit, so that the current flowing through each rechargeable battery can be limited so as not to exceed the value of current distributed to each of the rechargeable batteries when a current of a standard current limit value flows through each battery block when none of the interrupting devices is activated, i.e., the tolerable current value of respective rechargeable batteries. As a result, the risk of rechargeable batteries being deteriorated is readily reduced.

Preferably, a current control unit is further provided, which controls current flowing through the respective battery blocks not to exceed the current limit value set by the current limit setting unit.

With this configuration, current flowing through each battery block is controlled by the current control unit not to exceed the current limit value set by the current limit setting unit, so that, even if some of the interrupting devices are activated, the risk of the current flowing through the remaining intact rechargeable batteries being increased is reduced. As a result, the risk of rechargeable batteries being deteriorated is reduced.

Preferably, the current control unit sends the current limit value set by the current limit setting unit to an external apparatus that charges and discharges the plurality of battery blocks, thereby causing the external apparatus to control the current flowing through the plurality of battery blocks not to exceed the current limit value.

With this configuration, even when charging and discharging of the respective battery blocks are controlled by an external apparatus provided outside the battery power source apparatus, the current flowing through the battery blocks can be controlled not to exceed the current limit value by the external apparatus, with the current limit value being sent thereto by the current control unit. As a result, even if some of the interrupting devices are activated, the risk of the current flowing through the remaining intact rechargeable batteries being increased is reduced, whereby the risk of rechargeable batteries being deteriorated can be reduced.

Preferably, resistance values of the respective first resistors are set such that, in a case where one or a plurality of resistors are selected and combined out of the plurality of first resistors included in the parallel circuit, the resistance values of the combined resistance, obtained when the resistors of the combinations are connected in parallel, will be different, if the combinations of the resistors are different, and, an interrupting device specifying unit is further provided that specifies an activated interrupting device of the plurality of interrupting devices based on the voltage divider ratios.

With this configuration, the resistance values of the respective first resistors are set such that, in a case where one or a plurality of resistors are selected and combined out of the plurality of first resistors, the resistance values of the combined resistance, obtained when the resistors of the combinations are connected in parallel, will be different, if the combinations of the resistors are different. Therefore, depending on which of the interrupting devices is activated, the resistance value of the parallel circuit obtained from the first resistors connected in series to non-activated interrupting devices will be different. As a result, the voltage divider ratio changes in accordance with which of the interrupting devices is activated. Thus the interrupting device specifying unit can specify an activated interrupting device based on the voltage divider ratio.

Preferably, values of respective terms of the following geometric progression (A) are set as the resistance values of the respective first resistors, a j-th term being given as:

ar^{j-1} (A),

where a is an arbitrary constant, r is the common ratio larger than 0 and except for 1, and j is a positive integer.

With this configuration, the resistance values of the respective first resistors can be set such that, in a case where one or a plurality of resistors are selected and combined out of the plurality of first resistors, the resistance values of the combined resistance, obtained when the resistors of the combinations are connected in parallel, will be different, if the combinations of the resistors are different.

Preferably, a memory unit is further provided, which preliminarily stores voltage divider ratio information containing information specifying an activated interrupting device in a corresponding relationship with a voltage divider ratio between the parallel circuit and the second resistor, and the interrupting device specifying unit specifies an interrupting device, as the activated interrupting device, which is in a corresponding relationship, in the voltage divider ratio information stored in the memory unit, with a voltage divider ratio calculated by the voltage divider ratio calculating unit.

With this configuration, the voltage divider ratio information containing information specifying an activated interrupting device in a corresponding relationship with a voltage divider ratio between the parallel circuit and the second resistor is preliminarily stored in the memory unit. Therefore, the interrupting device specifying unit specifies an interrupting device corresponding to a voltage divider ratio calculated by the voltage divider ratio calculating unit as the activated interrupting device using the voltage divider ratio information stored in the memory unit, whereby it can readily specify the activated interrupting device.

A battery power source system according to the present invention includes the battery power source apparatus described above, and an external apparatus that charges and discharges the battery power source apparatus. The external apparatus includes a load circuit to which a discharge current is supplied from the plurality of battery blocks, a current supply unit that supplies a charge current to the plurality of battery blocks, and a charge/discharge control unit that adjusts the discharge current supplied from the plurality of battery blocks to the load circuit, and the charge current supplied from the current supply unit to the plurality of battery blocks such that current flowing through the battery blocks is within a range not exceeding the current limit value sent from the current control unit.

With this configuration, in a battery power source system including the battery power source apparatus described above, a load circuit to which a discharge current is supplied from the battery blocks of this battery power source apparatus, and a current supply unit that supplies a charge current to the battery blocks, even if some of the interrupting devices included in the battery blocks are activated, the risk of current flowing through the remaining intact rechargeable batteries being increased is reduced, so that the risk of the rechargeable batteries being deteriorated can be reduced.

This application is based on Japanese Patent Application No. 2010-194403 filed on Aug. 31, 2010, the contents of which are herein incorporated.

The specific embodiments and examples described in the section of the Description of Embodiments are given only for the purpose of clarifying the technical contents of the present invention. The invention should not be narrowly interpreted to be limited only to such specific examples, but rather, the invention can be embodied with various modifications within the spirit of the present invention and the scope of the claims stated in the following.

### INDUSTRIAL APPLICABILITY

The battery power source apparatus and the battery power source system using the same according to the present invention can favorably be used in electronic equipment such as mobile PCs, digital cameras, and mobile phones, vehicles such as electric cars and hybrid cars, hybrid elevators, power source systems incorporating solar cells or power generators combined with rechargeable batteries, and battery-based apparatuses or systems such as uninterruptible power supplies.

1. A battery power source apparatus, comprising:
a battery block formed by parallel-connecting a plurality of series circuits each formed of a rechargeable battery and an interrupting device for interrupting a charge and discharge path of the rechargeable battery;
a plurality of first resistors having respective one ends connected to connection points between the rechargeable batteries and the interrupting devices of the respective series circuits, and respective other ends connected to each other;
a second resistor having one end connected to a connection point of the respective other ends;
a power source unit that applies voltage to a series circuit of a parallel circuit and the second resistor by applying voltage between a connection point of the plurality of interrupting devices and the other end of the second resistor, the parallel circuit being formed by the plurality of interrupting devices and the plurality of first resistors;
a voltage divider ratio calculating unit that calculates a voltage divider ratio between the parallel circuit and the second resistor based on at least one of a voltage across the ends of the parallel circuit and a voltage across the ends of the second resistor; and
a judging unit that determines presence or absence of an activated interrupting device of the plurality of interrupting devices based on the voltage divider ratio.

2. The battery power source apparatus according to claim 1, comprising a plurality of the battery blocks, wherein
the plurality of the battery blocks are connected in series,
the plurality of first resistors and the second resistor are provided corresponding to each of the battery blocks,
the parallel circuit is formed corresponding to each of the battery blocks,
of the plurality of battery blocks, a specified battery block, which is a battery block having another battery block adjacent and connected thereto on a side of the interrupting device, uses this other battery block adjacent on the side of the interrupting device as the power source unit,
the other end of the second resistor corresponding to the specified battery block is connected to a connection point of a plurality of interrupting devices included in this other battery block adjacent on the side of the interrupting device of the specified battery block,
the voltage divider ratio calculating unit calculates respective voltage divider ratios corresponding to the respective battery blocks, and
the judging unit determines presence or absence of an activated interrupting device of the plurality of interrupting devices for each of the battery blocks, based on each of the voltage divider ratios.

3. The battery power source apparatus according to claim 2, wherein the judging unit obtains, for each of the battery blocks, a number of activated interrupting devices of the plurality of interrupting devices included in each of the battery blocks, based on each of the voltage divider ratios corresponding to the battery blocks.

4. The battery power source apparatus according to claim 2, further comprising an effective battery number obtaining unit that obtains a number of non-activated interrupting devices of the plurality of interrupting devices included in each of the battery blocks as a number of effective batteries for each of the battery blocks. based on each of the voltage divider ratios corresponding to the battery blocks.

5. The battery power source apparatus according to claim 4, further comprising a current limit setting unit that sets a current limit value indicative of a tolerable upper limit of current flowing through the plurality of battery blocks,
wherein the current limit setting unit sets the current limit value such that the smaller a minimum value of the number of effective batteries corresponding to each of the battery blocks obtained by the effective battery number obtaining unit is, the lower the current limit value is.

6. The battery power source apparatus according to claim 5, wherein the current limit setting unit sets a value, obtained by multiplying a standard current limit value, which is a current limit value when none of the plurality of interrupting devices included in each of the battery blocks is activated, by a ratio of the number of effective batteries to the number of rechargeable batteries included in one of the battery blocks, as the current limit value.

7. The battery power source apparatus according to claim 5, further comprising a current control unit that controls current flowing through the respective battery blocks not to exceed the current limit value set by the current limit setting unit.

8. The battery power source apparatus according to claim 7, wherein the current control unit sends the current limit value set by the current limit setting unit to an external apparatus that charges and discharges the plurality of battery blocks, thereby causing the external apparatus to control the current flowing through the plurality of battery blocks not to exceed the current limit value.

9. The battery power source apparatus according to claim 1, wherein
resistance values of the respective first resistors are set such that, in a case where one or a plurality of resistors are selected and combined out of the plurality of first resistors included in the parallel circuit, the resistance values of the combined resistance, obtained when the resistors of the combinations are connected in parallel, will be different, if the combinations of the resistors are different, and
an interrupting device specifying unit is further provided that specifies an activated interrupting device of the plurality of interrupting devices based on the voltage divider ratios.

10. The battery power source apparatus according to claim 9, wherein values of respective terms of the following geometric progression (A) are set as the resistance values of the respective first resistors, a j-th term being given as:
ar^{j-1} (A),
where a is an arbitrary constant, r is the common ratio larger than 0 and except for 1, and j is a positive integer.

11. The battery power source apparatus according to claim 9, further comprising a memory unit that preliminarily stores voltage divider ratio information containing information specifying an activated interrupting device in a corresponding relationship with a voltage divider ratio between the parallel circuit and the second resistor, wherein
the interrupting device specifying unit specifies an interrupting device, as the activated interrupting device, which is in a corresponding relationship, in the voltage divider ratio information stored in the memory unit, with a voltage divider ratio calculated by the voltage divider ratio calculating unit.

12. A battery power source system, comprising:
the battery power source apparatus according to claim 8; and
an external apparatus that charges and discharges the battery power source apparatus, wherein the external apparatus includes:
a load circuit to which a discharge current is supplied from the plurality of battery blocks;
a current supply unit that supplies a charge current to the plurality of battery blocks; and
a charge/discharge control unit that adjusts the discharge current supplied from the plurality of battery blocks to the load circuit, and the charge current supplied from the current supply unit to the plurality of battery blocks such that current flowing through the battery blocks is within a range not exceeding the current limit value sent from the current control unit.
